(19) United States
(12) Patent Application Publication
(10) Pub. No.: US 2004/0035162 A1
(43) Pub. Date: Feb. 26, 2004

(54) Fertiliser

(76) Inventors: Richard Henry Williams, Essex (GB); Peter Harding, Hampshire (GB)

Correspondence Address: Neil A. DuChez, Renner, Otto, Biosselle & Sklar, LLP, 1621 Euclid Avenue, Nineteenth Floor, Cleveland, OH, 44115, US

(21) Appl. No.: 10/601,074

(22) Filed: Jun. 20, 2003

Related U.S. Application Data
(63) Continuation-in-part of application No. 09/889,800, filed on Oct. 12, 2001.
Application No. 09/889,800 is a 371 of international application No. PCT/GB00/00367, filed on Feb. 7, 2000.

(30) Foreign Application Priority Data
Feb. 5, 1999 (GB) 9902665.0

(51) Int. Cl. C05C 9/00

(52) U.S. Cl. 71/28

(57) ABSTRACT

The present invention provides a liquid fertiliser comprising a mixture of a salt of phosphorous acid together with either a thiosulphate such as ammonium or potassium thiosulphate and/or a salt of salicylic acid or salicylamide. The use of this combination as a foliar spray, soil drench or irrigation component produces a greater fertiliser effect (on plant vigour and growth) and greater resistance to or control of parasitic fungal diseases, than each of the components applied individually or any combination of just two components.

The present invention relates to novel compositions having fertilising and anti-fungal effects, to processes for their preparation, and to methods of fertilising plants and controlling fungi using them.

Phosphorus is one of the essential major elements required by plants and it is usually supplied to plants in the form of phosphate and/or polyphosphate. Phosphates are the salts of phosphoric acid (having the formula H₃PO₄ and molecular weight of 98). In recent years, it has been shown that plants can obtain phosphorus from phosphonates (sometimes also referred to as phosphites) which are the salts (organic or inorganic) of phosphonic acid (also referred to as phosphorous acid) (having the formula H₃PO₃ and molecular weight of 82). See, for example, U.S. Pat. Nos. 5,514,200 & 5,830,255 to Lovatt; U.S. Pat. No. 5,707,418 to Hsu; U.S. Pat. No. 5,800,837 to Taylor. These describe formulations containing phosphorous acid or phosphonates suitable as fertilisers for plants. It has also been shown that phosphonate compounds are useful as fungicides, especially where the fungal organisms are phycomycetes or oomycetes. See, for example, U.S. Pat. Nos. 4,075,324 & 4,119,724 to Thizy; U.S. Pat. No. 4,139,616 to Lacroix et al; U.S. Pat. Nos. 4,698,334, 4,806,445 & 5,169,646 to Horriere et al; U.S. Pat. Nos. 4,935,410 & 5,070,083 to Bartlet; U.S. Pat. No. 5,736,164 to Taylor. These describe formulations, containing phosphorous acid or phosphonates, suitable as fungicides for plants.

Ammonium thiosulphate and potassium thiosulphate, either alone or mixed with other liquid fertiliser components, have been used for many years as fertilisers. See literature on “Thio-sul”® and KTS® sulphur fertilisers produced by Tessenderlo Kerley. See also UK Patent No. GB 2,259,912 to Sampson, which describes the use of ammonium thiosulphate in a plant growth stimulator.

WPI Abstract Accession No. 91-249421 discloses a cut flower preserving agent comprising a water-soluble silver salt (100 pts. wt.) and thiosulphate (300-2500 pts. wt.) to which a phosphite (30-300 pts. wt.) is added as a stabilising agent.

Some of the problems with the prior art are that the fertilising effect of phosphonate is less than might be expected from the amount of phosphorus applied, and the fungicidal effect is fairly limited in terms of the types of pathogen controlled. This is due to a complex mode of action involving a combination of some fungistatic action and natural plant defences coming into play (See Guest D I & Grant B R (1991)—The Complex action of phosphonates in plants—Biological Reviews 66, 159-187). The use of phosphonate, whilst improving the resistance of plants to infections of downy mildew (e.g. Plasmopora) and Phytophthora diseases, does tend to increase the risk of ascomycete (e.g. Erysiphe) infections. The present invention seeks to provide a solution to these problems.

According to one aspect of the present invention there is provided a fertiliser composition comprising at least one phosphonate and at least one thiosulphate.

According to another aspect of the present invention there is provided a fertiliser composition comprising at least one phosphonate and at least one salicylic acid, homologue, derivative, or salt thereof.

According to yet another aspect of the present invention there is provided a fertiliser composition comprising at least one thiosulphate and at least one salicylic acid, homologue, derivative, or salt thereof.

According to a further aspect of the present invention there is provided a fertiliser composition comprising at least one thiosulphate, at least one phosphonate and at least one salicylic acid, homologue, derivative, or salt thereof.

The present invention comprises using a mixture of a phosphonate together with either a thiosulphate, or at least one salicylic acid, homologue, derivative, or salt thereof. The use of this combination shows a synergistic effect, in that the combination of phosphonate with thiosulphate or salicylic acid, homologues, salts or derivatives thereof produces a greater fertiliser effect and fungicidal effect than the individual components used separately. There may be an even greater effect if all three components (i.e. phosphonate, thiosulphate and salicylic acid, homologue, salt or derivative thereof) were used together. The combination of thiosulphate with a salicylic acid, homologue, salt or derivative thereof, in the absence of phosphonate, also produces a fertiliser effect and fungicidal effect.

Fertilisers based on the present invention provide a greater growth effective response than phosphonates or thiosulphates alone and the degree of fungicidal protection or resistance is broader than that achieved with phosphonates or thiosulphates alone. Plants treated with the present invention suffer less from phycomycete diseases (for example phytophthoras and downy mildews) than those treated with for example phosphonate alone and are also less prone to other parasitic fungi such as powdery mildews. Thus the present invention provides a means for applying a single product to plants which is an effective fungicide as well as an effective fertiliser.

Another advantage of the present invention is that the formulation is very storage stable, for example tests on mixtures of potassium phosphonate and ammonium thiosulphate stored for over one year have shown that there is no oxidation of the phosphonate to phosphate and the stored material shows no signs of cloudiness or precipitation. The use of further organic acids as buffers (as in required in U.S. Pat. Nos. 5,514,200 & 5,830,255) is also not required to achieve stable solutions.

By “phosphonate” we mean a salt of phosphonic acid (H₃PO₃). Phosphonates contain the trivalent ≡PO₃ radical. For the avoidance of doubt, phosphonic acid is sometimes referred to as phosphorous acid and its salts as phosphites. Mixtures of phosphonates may be employed.

The phosphonate may be any metal ion or other cation which forms such a salt. As phosphonic acid has a P—H bond it forms a mono and di series of salts. Both mono and di salts and mixtures thereof may be used in the present invention. Preferably the phosphonate is an ammonium phosphonate or alkali phosphonate. Amongst the alkali phosphonates, sodium or potassium phosphonate are preferred. Potassium phosphonate is particularly preferred, in the form of mono- and/or di-potassium phosphonate (KH₃PO₃, K₂HPO₃ respectively).

Phosphonates may be produced by the neutralisation of phosphonic acid by an alkali. The present invention also encompasses the use of phosphonic acid which is subsequently converted to its phosphonate; this conversion may take place in situ or ex situ. When using, for example, potassium hydroxide for the neutralisation, depending on the molar ratio of potassium hydroxide to phosphorous acid, the phosphonate solution will contain varied amounts of di-potassium phosphonate, mono-potassium phosphonate and un-reacted phosphorous acid. We have found that an approximately 42% w/w solution, having a pH of between 6.7 and 7.3 and containing approximately equal amounts of mono- and di-potassium phosphonate is a clear, colourless and very stable starting material for our present invention.

The thiosulphate may be any suitable salt of a metal or other cation. Preferably the thiosulphate is ammonium, sodium or potassium thiosulphate or a mixture thereof. More preferably the thiosulphate is in the form of either ammonium or potassium thiosulphate ((NH₄)₂S₂O₃ or K₂S₂O₃).

The most common form of thiosulphate is ammonium thiosulphate, and this is readily available commercially as a 60% w/w solution, with a pH of about 7.5 and a specific gravity of about 1.32. If a higher proportion of potassium is required in the final foliar fertiliser, the ammonium thiosulphate can be substituted, either partly or wholly, with potassium thiosulphate.

The present invention includes functional homologues and derivatives of salicylic acid and its salts. By this we mean that the functional homologue or derivative should be capable of providing a fertiliser effect and/or antifungal effect. Examples of such derivatives of salicylic acid include salicylamide or a salt thereof, and esters.

Examples of homologues of salicylic acid include benzoic acid or a salt or derivative thereof, such as an ester. Examples of benzoic acid compounds which may be used in the present invention may be found in WO99/25191.

The salicylic acid is preferably in the form of its potassium salicylate salt or salicylamide —C₇H₅KO₃ or C₇H₇NO₂.

Salicylic acid itself has low solubility, but inorganic salts of salicylic acid, such as sodium or potassium salicylate are readily soluble. When salicylamide is used, rather than salicylic acid or a salicylate, the addition of a few drops of alkali assists in its solution, by forming for example sodium or potassium salicylamide. Salicylamide also dissolves more readily in the thiosulphate solution, the presence of small amounts of alkali or ammonia in the thiosulphate solution assisting in the solubilisation.

The preparation of the compounds used in the present invention is well known in the art. The compounds may be prepared in situ or ex situ.

In one embodiment, the composition of the present invention does not include a water-soluble silver salt. In another embodiment, if the composition contains a solution of 100 parts by weight water-soluble silver salt, and 300-2500 parts by weight thiosulphate, then the amount of phosphonate is other than 30 to 300 parts by weight.

The compositions of the present invention are useful as fertiliser, particularly foliar fertilisers. More particularly the compositions of the present invention increase plant growth compared to the individual components alone, stimulate growth in plants, plant vigour and/or effect crop yield, for example by reducing tuber blight.

The compositions of the present invention also have an antifungal effect. This may be a fungicidal or fungistatic effect. The compositions of the present invention may have activity against parasitic fungi. The compositions may have activity against phycomycete diseases such as phytophthoras and downy mildews, for example, Plasmopora; and/or ascomycetes such as, for example, Erysiphe.

In one particularly preferred embodiment the composition further comprises further a plant growth regulator. Preferably the plant growth regulator is chlormequat.

In order to apply the composition to the plant or environs of the plant, the composition may be used as a concentrate or more usually is formulated into a composition which includes an effective amount of the composition of the present invention together with a suitable inert diluent, carrier material and/or surface active agent. Preferably the composition is in the form of an aqueous solution which may be prepared from the concentrate. By effective amount we mean that the composition (and/or its individual components) provides a fertilising and/or antifungal effect. Preferably an effective amount of the components is a concentration of up to about 4M phosphonate, up to about 5M thiosulphate and/or up to about 0.8M salicylate. Thus, in one embodiment the concentrate may comprise up to about 10M of the components. The concentrate formulation may for example be diluted at ratios of concentrate to water of about 1:40 to 1:600, and generally is formulated to have pH of about 6.5 to 8.5. At a 1:40 dilution, a concentrate of about 10M would give rise to an application concentrate of up to about 0.25M.

The rate and timing of application will depend on a number of factors known to those skilled in the art, such as the type of species etc.

The composition is generally applied in an amount of from 0.01 to 10 kg per hectare, preferably 0.1 to 6 kg per hectare. Preferably the phosphonate is applied at 150 g/ha to 2 kg/ha. Preferably the thiosulphate is applied at 250 g/ha to 6 kg/ha. Preferably the salicylic acid, a homologue, derivative, or salt thereof is applied at 1 g/ha to 100 g/ha.

In one preferred embodiment, a fertiliser composition according to the present invention comprises about 150 g/l phosphonate, about 275 g/l thiosulphate and/or about 10 g/l salicylamide. Preferably the phosphonate comprises about 75 g/l mono-potassium phosphonate and about 75 g/l di-potassium phosphonate.

As well as varying amounts of each compound to be blended together, as is common with many foliar fertilisers, it is also possible to combine other fertilising elements, such as but not limited to, iron, copper, calcium, magnesium, manganese, potassium, zinc, boron, molybdenum, selenium and their salts (often known as micronutrients) in the final solution. These may be added as soluble inorganic compounds (e.g. magnesium sulphate, calcium nitrate, sodium borate, magnesium nitrate, ammonium or sodium molybdate, and mixtures thereof) or as chelates (e.g. copper EDTA or chelated complexes of calcium, iron, zinc, magnesium or manganese) or other metal complexes.

The compositions of the present invention can be applied to the soil, plant, seed, or other area to be protected. Preferably the present invention is applied to the foliage of plants. The composition may be applied in the form of dusting powders, wettable powders, granules (slow or fast release), emulsion or suspension concentrates, liquid solutions, emulsions, seed dressings, or controlled release formulations such as microencapsulated granules or suspensions, soil drench, irrigation component, or preferably a foliar spray.

Dusting powders are formulated by mixing the active ingredient with one or more finely divided solid carriers and/or diluents, for example natural clays, kaolin, pyrophyllite, bentonite, alumina, montmorillonite, kieselguhr, chalk, diatomaceous earths, calcium phosphates, calcium and magnesium carbonates, sulfur, lime, flours, talc and other organic and inorganic solid carriers.

Granules are formed either by absorbing the active ingredient in a porous granular material for example pumice, attapulgite clays, filler's earth, kieselguhr, diatomaceous earths, ground corn cobs, and the like, or on to hard core materials such as sands, silicates, mineral carbonates, sulfates, phosphates, or the like. Agents which are commonly used to aid in impregnation, binding or coating the solid carriers include aliphatic and aromatic petroleum solvents, alcohols, polyvinyl acetates, polyvinyl alcohols, ethers, ketones, esters, dextrins, sugars and vegetable oils, with the active ingredient. Other additives may also be included, such as emulsifying agents, wetting agents or dispersing agents.

Microencapsulated formulations (microcapsule suspensions CS) or other controlled release formulations may also be used, particularly for slow release over a period of time, and for seed treatment.

Alternatively the compositions may be in the form of liquid preparations to be used as dips, irrigation additives or sprays, which are generally aqueous dispersions or emulsions of the active ingredient in the presence of one or more known wetting agents, dispersing agents or emulsifying agents (surface active agents). Examples of emulsifying/wetting agents include mono-, di- or tri-styrylphenol, naphtol, mono-, di- or tri-styrylnaphtol, dicyclehexylphenol, mono-, di- or tri-styrylphenylphenol, benzylphenol, formaldehyde condensed phenol, formaldehyde condensed naphtol, N—C₄₋₁₆ alkylpyrrolidone, hydrocarbylcarboxylid amide, ricinus oil, sorbitol, phenylphenol, alkyl phenolethylene oxide condensate, triton X100, Cittowet (trademark BASF), alkylated aromatic sodium sulphonate, amine salts or sulphated fatty alcohols and tall oil. The compositions which are to be used in the form of aqueous dispersions or emulsions are generally supplied in the form of an emulsifiable concentrate (EC) or a suspension concentrate (SC) containing a high proportion of the active ingredient or ingredients. An EC is a homogeneous liquid composition, usually containing the active ingredient dissolved in a substantially non-volatile organic solvent. An SC is a fine particle size dispersion of solid active ingredient in water. To apply the concentrates they are diluted in water and are usually applied by means of a spray to the area to be treated.

Suitable liquid solvents for ECs include methyl ketone, methyl isobutyl ketone, cyclohexanone, xylenes, toluene, chlorobenzene, paraffins, kerosene, white oil, alcohols (for example, butanol), methylnaphthalene, trimethylbenzene, trichloroethylene, N-methyl-2-pyrrolidone and tetrahydrofurfuryl alcohol (THFA).

These concentrates are often required to withstand storage for prolonged periods and after such storage, to be capable of dilution with water to form aqueous preparations which remain homogeneous for a sufficient time to enable them to be applied by conventional spray equipment. The concentrates may contain 1-85% by weight of the active ingredient or ingredients. When diluted to form aqueous preparations such preparations may contain varying amounts of the active ingredient depending upon the purpose for which they are to be used.

The composition may also be formulated as powders (dry seed treatment DS or water dispersible powder WS) or liquids (flowable concentrate FS, liquid seed treatment LS), or microcapsule suspensions CS for use in seed treatments. The formulations can be applied to the seed by standard techniques and through conventional seed treaters. In use the compositions are applied to the plants, to the locus of the plants, by any of the known means of applying fertiliser compositions, for example, by dusting, spraying, or incorporation of granules.

When the final solution is to be applied to plants which, because of their hairy or waxy surface, may be difficult to wet, it may also be advantageous to include other additives, commonly known in the agrochemical industry, such as surfactants, wetting agents, spreaders and stickers. (Examples of wetting agents include silicone surfactants, nonionic surfactants such as alkyl ethoxylates, anionic surfactants such as phosphate ester salts and amphoteric or cationic surfactants such as fatty acid amido alkyl betaines).

As indicated above, the compounds of the invention may be the sole active ingredient of the composition or they may, where appropriate, be admixed with one or more additional active ingredients such as general pesticides (for example, anilide microbicidal compound, anilines, benomyl, bordeaux mixture, carboxin, chlorothalonil, chloropyriphos, cyclohexamines, cyhexatin, cymoxanil, dichlorvos, dificol, dimethoate, dimethomorph, dinzinon, dithicarbonimide compounds, dithiocarbamate fungicide, ethylenebis compounds, feninitrothion, fentin hydroxide, fosetyl, imidazoles, porpholines, pthalimide microbicidal compound, pyrethrum, streptomycin, substituted aliphatic, aromatic, alicyclic or heterocyclic amines), nematicides, insecticides (non-limiting examples of insecticides include azinophozmethyl, carbaryl, DDT, demephion, dementon-S-methyl, demifox, dimethoate, DNOC, fenitrothion, fonofos, lindane, malathion, menazon, phosalone, phophamidon, pirimiphos-methyl, ponofos, pyrimicarb, triazophos, trichlorophon and vamidothion), synergists, herbicides (such as amitraz, asulam, atrazine, barban, bensultap, benzoyl-propethyl, bilanofos, chlorfenprop-methyl, chlotoluron, dalapon, dazomet, desmetryme, diallate, diclofop-methyl ethofumasate, difenzoquat, elementary sulphur, flamprop methyl, flamprop-isopropyl, flumethon, gluphosinate, glyfosate, glyphosine, isoproturon, lindane, linuron, mancozeb, methyl bisthiocyanate, nitrofen, phenmedipham, propyzamide, simazine, thiophanat-methyl, triallate, trifluralin, triforine and hormone type weedkillers (such as MCPA, 2,4-D MCPB, 2,4 DB, Mecoprop, cichloroprop, Ioxynil, bromoxynil, benzolin, bentazone, cyanazine, dicamba, dinoseb-amine, dinoseb-acetate)), additional fungicides (non-limiting examples of fungicides include benodanil, binapacryl, bupirimate, captafol, captan, carbendazim, demethirimol, ditalimfos, dodine, ethirimol, malathion, mancozeb, maneb, pyraphos, sulphur, thiabenzadole, thiophanate-methyl, thiram, triazophos, triademiphon, tridemorph, triforine, vinclozin and zineb), additional fertilisers or plant growth regulators (such as, cytokinins (including, but not limited to kinetin, zeatin and the like), purines, gibberellins (including, without limitation, gibberellic acid), auxins and mixtures thereof, acetaminophen (N-acetyl-p-hydorxy aminophenol), anthranilic acid (2-aminobenzoic acid), indole-3-acetic acid, indole-3-butyric acid, naphthalene acetic acid, α-naphthylacetonitrile, chlorocholine chloride (beta-chloro ethyltrimethylammonium chloride or chlormequat), haloalkyl phosphoric acids, chlorophium chloride, mepiquat chloride, diphenyl-1-Hyrazolium salts, chitosan for example in combination with lactic, glutamic or succinic acid, heteroauxin, fluoroxane, FF806, catapol, 8 hydroxy quinoline, 1,3 diphenyl urea, 6-(benzyl amino) purine (6-benzyl adenine), 6-furfuryl amino purine, brassinolides, β-phenylethylamine, abscisic acid, jasmonates, oligosaccharines, humic acid (or one of its constituents), fulvic acid, N-(phenylmethyl)-9-(tetrahydro-2H-pyran-2-yl)-9H-purin-6-amine and extract of sea weed).

The composition of the present invention may also comprise one or more conventional ingredients suitable for use in a fertiliser composition. Non-limiting examples of such components include organic acids (e.g. citrate, pyruvate, succinate, fumarate, malate, formate, oxaloacetate, cis-aconitate, isocitrate, α-ketglutarate, glutamic acid, aspartic acid, ascorbic acid, acetyl, salicylate, fumaric acid, malic acid, malonic acid, oxalic acid, tartaric acid, citric acid, succininc acid, malic acid, pyruvic acid, acetic acid, fumaric acid, sucrose, butyric acid, lauric acid, palmitic acid, stearic acid, alginic acid, laminarin, oleic acid and linoleic acid), other carbon sources (e.g. fructose, sorbitol, dextrose, lactose, glycerol, glyceraldehyde, erythrose, ribulose, xylulose, arabinose, glucose, hydrolysed starch, sucrose, potassium citrate, potassium fumarate, potassium oxalate, potassum acetate, sodium acetate, sodium citrate, sodium formate, sodium fumarate, sodium malate, sodium malonate, sodium oxalate, sodium succinate, succininc acid and mixtures and derivatives thereof), phosphorus containing acids (e.g. phosphorous acid, polyphosphorous acid, hypo phosphorous acid, polyhypophosphorous acid, phosphite (the salt of phosphorous acid), polyphosphoric acid as a complexing agent), amino acids (such as glycine, alanine, valine, leucine, isoleucine, serine, threonine, cysteine, methionine, aspartic acid, glutamic acid, glutamine, asparagine, lysine, hydroxylysine, arginine, histidine, phenylalanine, tyrosine, tryptophan, proline, betaines, choline, glycine, and hydroxyproline), coenzyme precursors, vitamins and nucleic acids (e.g. Thiamine mononitrate, thiamine hydrochloride, niacin, d-Biotin, riboflavin, ascorbic acid, pyridoxine, pyridoxamine, pyridoxal, pyridozine hydrichloride, nicotinamide, folic acid, adenine, adenosine, thymine, thymidine, thiamine, cytosine, guanine, guanosine, hypoxanthine, uracil, uridine and inosine), fatty acids (for example butyric acid, lauric acid, palmitic acid, stearic acid, oleic acid and linoleic acid), nitrogen sources (e.g. urea, urea phosphate, ammonium nitrate, ammonium phosphate, aluminium tris ethyl phosphonate, ammonium acetate, ammonium citrate, ammonium fumarate, ammonium malate, ammonium molybdate, ammonium oxalate, ammonium sulphate, ammonium thiosulphate, ammonium succinate, and quaternary ammonium salts of the formula R—N—(CH₃)₃—Y where Y is a non-phytotoxic anion and R is a lower aliphatic radical (C₁₋₆ or C₁₋₈) maintaining a non-ionizing nucleophilic group or atom).

Among conventional ingredients suitable for use in fertilisers are compounds providing the usual fertilizer macro-elements of nitrogen, phosphorus, potassium and sulfur. Non-limiting examples of such compounds include ammonium nitrate, ammonium sulfate, urea, urea phosphate, potassium nitrate, potassium carbonate, potassium chloride, potassium sulfate, mono-ammonium phosphate, di-ammonium phosphate, ammonium polyphosphate, phosphoric acid and its salts.

The compostition may also include agents for inducing stress tolerance (such as phenyl carboxylic acid derivates, paclabutrzol, uniconzole, triadimephron, polyamine compounds and spermidine), coating agents (for example, sesquiterpenes, diterpenes, triterpenes, tetraterpenes, bicyclic and tricyclic, onoterpenes, terpene resins, Gum terpenes, sulphate of terpentine, wood turpentine, pine oils, terpineons, non oxidizing alkyd resins (such as those of castor oil, coconut oil, hydrogenated castor oil, lauric acid, oil-free, saturated acid and synthetic fatty acid types), oxidising alkyd resins (such as acrylic-resin-modified dehydrated castor oil types, epoxide-resin-modifed, isopthalic-acid-based-types, linoleic-rich oil types, linseed oil types, linseed oil/dehydrated castor oil types, maleic-resin-modified, marine oil types, linseed oil/tung oil types, Maleic-resin-modified, rosin-modified, safflowerseed oil types, silicome-resin-modified, soya bean oil types, tall oil types, tabaccoseed oil types, unmodified types, vinyl toluene-modified and water soluble types), benzogaunamine resins, resins, copal ester resins, resylic resins, epoxy resins (for example dehydrated castor oil types, linseed oil types, linseed oil/rosin types, phenolic-resin-modified, soya bean oil types, styrenated types, vinyltoluene-modified, um-modified types, epikote 828 and epikote 1001), epoxide melamine condensates, epoxide phenolic condensates, ester gums, fumaric resins, furan resins, ketone resins, mealeic resins, melamine resins, metallic rosinates (for example, calcium and zinc resinates, zinc/calcium mixtures, both rosin and modified rosin), phenolic resins, phenoxy resins, polybutadiene resins, polybutene resins, poly carbonate resins, polyisobutaylene resins, polyester resins, polysulphide resins, polyurethane resins, polyvinyl acetal resins, polyether resins, polyvinyl resins, rosin derivatives (for example, esters of rosin, copal, rosin acids or rosin modified by hydrogenation, polymerization, isomerization, or disproportionation with glycerol, pentaerythritol or other polyhydric alsohols) silicone resins, urea resins (for example, urea-formaldehyde), xylene-, maleic/fumaric condensate resins (for example, maleic or fumaric acid/anhydride adducts on rosin or modified rosins, their esters with glycerol, pentaerythritol or other polyhydric alcohols), formaldehyde resins, natural gums and resins (e.g. accoroides, arabic,bezoin, copals, damar, elemi, gamboge, karaya, mastic, rosin, sandarac, shellac, tragacanth), acrylic polymers and copolymers, cellulose esters (e.g. methyl cellulose), hydrocarbon resins (e.g. petroleum resins), polyamide resins, rubbers (e.g. natural ruuber, butyl rubber, nitrile rubber, polycholoroprane, rubber/oil emuline and polyurethane rubber, cyclized rubber resins), vinyl polymers and copolymers (e.g. poly (vinyl acetate), poly (vinyl alcohol), poly (vinyl butyral), poly (vinyl pyrrolidone) poly (vinyl acetate/vinyl chloride) and poly (vinyl acetate/acrylate), acrylic polymers and copolymers (for example, polyacrylic acid, poly acrylamide, polyacrylonitrile, poly (methyl methacrylate) and poly (ethyl acrylate/butyl acrylate), natural drying oils (e.g. linseed oil and tung oil and mixtures of them), wood terpentine, benzoguanamine resins, styrene polymers and copolymers (for example, polystyrene and styrene/maleic anhydride and butadiene/styrene copolymer resins), copal ester resins, carbmine resins, coumarone-indene resins, cresylic resins, natural drying oils with or without metal accelerators (eg linseed oil and tung oil or mixutres of them), chemicals that screen out UV damage (e.g. pine oils, oils of lemon, olive, coconut and jujuba, substances such as borneol, limonene and terpineol, cinnamic aicd, hydroxy-cinnamic acid, benzoic acid and salts of these acids), free radical reducers (e.g. oxidized glutathione and ascorbic acid) and desiccants (e.g. diquat, dinoseb and glyphosate) where appropriate.

The composition of the present invention may also include nutrients such as a source of calcium, iron, magnesium, manganese, copper and zinc, and particularly sulfates, chlorides or nitrates thereof.

The composition may also include, as pesticides, compounds which are used in the food industry, such as compounds which release chlorine in water, e.g. calcium hypochlorite, sodium bypochlorite, sodium dichloroisocyanurates; compounds which release sulphur dioxide in water, e.g. sodium metabisulphite; benzoic acid and salts (eg sodium benzoate); acetic acid; sorbic acid; formalin/formaldehyde; methyl, ethyl and propyl 4-hydroxybenzoates and their sodium salts; propionic acid and its salts; hexamine; biphenyl; ascorbic acid and its salts; 2 hydroxybiphenyl and its sodium salts; 2-thiazol-4-yl-benzimidazole; the nitrate and nitrite of sodium and potassium; and nisin.

The composition may also include carbohydrates and/or polysaccharides. Suitable carbohydrates and polysaccharides are selected from among alginic acid, mannitol, laminarin, succinic acid, sorbitol, fructose, sucrose, dextrose and lactose.

The composition may also usefully comprise one of more adjuvants. Useful adjuvants include alcohol ether sulfates, alcohol sulfates, alkylaryl ether sulfates, alkylaryl sulfonates, carboxylated nonionics, naphthalene, sulfonates, phosphate esters, sulfonic acids, sulfosuccinates, terpenes, alcohol ethers, alkoxylated alkylphenol resins, alkoylated vegetable oils, esterified seed oils, alkylphenol ethers, block co-polymers, sorbitol, sorbitan alkoxylates and sorbitan esters, alkanolamides, amine ethoxylates, methyl esters of fatty acids, fatty acid alkyloxalates and fatty acid resins, and terpene, such as α- or β-terpene.

As indicated above, the fertilisers produced according to this present invention are usually applied to the foliage of plants but may also be applied to the soil or added to the irrigation water. The fertilisers may be used advantageously on many types of agricultural and horticultural crops, including but not limited to, cereals, legumes, brassicas, cucurbits, root vegetables, sugar beet, grapes, citrus & other fruit trees and soft fruits. More particularly, crops that will benefit from the fertiliser include, but are not limited to, peas, oil seed rape, carrots, spring barley, avocado, citrus, mango, coffee, deciduous tree crops, grapes, strawberries and other berry crops, soybean, broad beans and other commercial beans, corn, tomato, cucurbitis and other cucumis species, lettuce, potato, sugar beets, peppers, sugar cane, hops, tobacco, pineapple, coconut palm and other commercial and ornamental palms, rubber and other ornamental plants.

Various further preferred features and embodiments of the invention will now be described by reference to the following non-limited Examples.

### EXAMPLE 1

Solution 1

An aqueous solution containing a total of 30% by weight of mono and di-potassium phosphonate in roughly equal proportions.

Solution 2

An aqueous solution containing 55% by weight of ammonium thiosulphate (“ATS”).

Solution 3

An aqueous solution containing 20 grams per litre of potassium salicylamide.

Solution 4

An aqueous solution containing 75 g/L mono potassium phosphonate, 75 g/L di-potassium phosphonate, 275 g/L ammonium thiosulphate and 10 g/L potassium salicylamide.

These solutions were applied to lettuce plants, both alone and in combination, and the applications were repeated after a 10 day interval. There were five replicates of each treatment and the results are presented as means of the five replicates. Five plants were also left unsprayed as an untreated control to the other treatments. After eight, twelve, sixteen and twenty-one days, the plants were examined for disease.

TABLE 1
Powdery Mildew Score (0-9, where higher number equals greater
degree of disease)

| Treatment | | | |
|---|---|---|---|
| (Applied initially and repeated | Days after first spray | | |
| 10 days later) | 8 days | 12 days | 16 days |
| Untreated | 4.0 | 6.6 | 7.2 |
| Solution 1 (1 L/ha) | 0.8 | 2.2 | 3.6 |
| Solution 2 (1 L/ha | 1.0 | 1.2 | 2.4 |
| Solution 3 (1 L/ha) | 1.6 | 3.2 | 4.2 |
| Solution 1 (1 L/ha) + | 0.0 | 0.4 | 1.0 |
| Solution 2 (1 L/ha) | | | |
| Solution 1 (1 L/ha) + | 0.4 | 0.6 | 1.0 |
| Solution 3 (1 L/ha) | | | |
| Solution 1 (1 L/ha) + | 0.8 | 0.6 | 0.6 |
| Solution 2 (1 L/ha) + | | | |
| Solution 3 (1 L/ha) | | | |

Table 1 shows the synergistic effect on disease levels achieved by adding Solutions 1 & 2 (phosphonate+ATS) and between Solutions 1 & 3 (phosphonate+salicylamide) and the further effect of using all three solutions together. Disease levels were reduced from a mean of 7.2 to a mean of 0.6.

As well as assessing disease levels, the growth of the plants was assessed by measuring the mean plant diameters after 35 days growth and by measuring the mean above ground fresh and dry weights.

TABLE 2
Plant Growth after treatment with the example solutions

| | Amount of | | | |
|---|---|---|---|---|
| Treatment | Rooting | Plant | Above-Ground | Above-Ground |
| (Applied initially and | (0-9, 0 = least | Diameter | Fresh Weight | Dry Weight |
| repeated 10 days later) | rooting) - mean | (mm) - mean | (g) - mean | (g) - mean |
| Untreated | 5.3 | 124 | 102.3 | 8.3 |
| Solution 1 (1 L/ha) | 6.0 | 148 | 116.3 | 9.3 |
| Solution 2 (1 L/ha | 5.3 | 160 | 109.0 | 8.7 |
| Solution 3 (1 L/ha) | 4.7 | 150 | 104.7 | 8.5 |
| Solution 1 (1 L/ha) + | 6.7 | 144 | 119.0 | 9.5 |
| Solution 2 (1 L/ha) | | | | |
| Solution 1 (1 L/ha) + | 6.7 | 170 | 120.7 | 9.7 |
| Solution 3 (1 L/ha) | | | | |
| Solution 1 (1 L/ha) + | 6.7 | 168 | 131.7 | 10.6 |
| Solution 2 (1 L/ha) + | | | | |
| Solution 3 (1 L/ha) | | | | |

Table 2 shows the synergistic effect on plant growth caused by adding Solutions 1 & 2 (phosphonate+ATS), Solutions 1 & 3 (phosphonate+salicylamide) and the further effect of using all three solutions together.

The abbreviations used in the following Examples A-E are:

A=phosphonate+thiosulphate

B=phosphonate+salicylate/salicylamide

C=thiosulphate+salicylate/salicylamide

D=thiosulphate+salicylate/salicylamide+phosphite

E=thiosulphate+salicylate+chlormequat

KP40=40% potassium phosphonate

KT47=47% potassium thiosulphate (w/v)

KS20=20% potassium salicylate (w/v)

CS8=salicylamide (20g/l)

AT60=60% ammonium thiosulphate

PF723=55% armnonium thiosulphate

### EXAMPLES A

Solution 1=KP40 at, 0.75 l/ha every 10 days

Solution 2=PF723 at 1.0 l/ha every 10 days

TABLE A1
Percent Powdery Mildew - Lettuce

| Treatment (Applied | | | |
|---|---|---|---|
| initially and repeated | Days After First Spray | | |
| after a 10 day interval) | 8 Days | 12 Days | 16 Days |
| Untreated | 40 | 66 | 72 |
| Solution 1 (1 L/Ha) | 8 | 22 | 36 |
| Solution 2 (1 L/Ha) | 10 | 12 | 24 |
| Solution 1 (1 L/Ha) + | 0 | 4 | 10 |
| Solution 2 (1 L/Ha) | | | |

TABLE A2
Percent Powdery Mildew and Fertiliser Attributes - Sugar Beet

| | | | Above Ground Fresh |
|---|---|---|---|
| Treatment (Applied | Days After First Spray | | Weight |
| initially and repeated | +28 Days | +35 Days | (g) - Mean |
| after a 10 day interval) | (×1 Rate | (×1 Rate) | (×1 Rate) |
| Untreated | 22 | 31 | 144.7 |
| Solution 1 | 6 | 4 | 152.3 |
| Solution 2 | 2 | 2 | 153.3 |
| Solution 1 + | 0 | 0 | 154.3 |
| Solution 2 | | | |

TABLE A3
Fertiliser Attributes - Spring Barley

| | Plant Health | | | Amount of |
|---|---|---|---|---|
| Treatment (Applied | ‘Greenness’ | Above Ground | Above Ground | Above Ground |
| initially and repeated | Score (0-9) | Fresh Weight | Dry Weight | Tissue (0-9) at |
| after a 10 day | +35 Days | (g) - Mean | (g) - Mean | Harvest |
| interval) | (×1 Rate) | (×1 Rate) | (×1 Rate) | (×1 Rate) |
| Untreated | 5.6 | 68.8 | 7.7 | 5.0 |
| Solution 1 | 5.6 | 67.0 | 7.4 | 5.3 |
| Solution 2 | 5.4 | 68.3 | 7.2 | 5.3 |
| Solution 1 + | 6.6 | 72.7 | 7.9 | 6.0 |
| Solution 2 | | | | |

TABLE A4
GRAPE TRIAL
Percent Powdery Mildew

| Treatment (Applied initially | Days After First Spray | | | | | |
|---|---|---|---|---|---|---|
| and repeated at 10 day | +16 | +20 | +24 | +28 | +32 | +36 |
| intervals) | Days | Days | Days | Days | Days | Days |
| Untreated | 7.3 | 9.3 | 11.3 | 14.0 | 14.0 | 14.7 |
| KP40 @ 0.75 l/ha | 5.3 | 6.7 | 8.0 | 11.3 | 10.7 | 10.7 |
| PF723 @ 1.0 l/ha | 2.7 | 7.3 | 7.3 | 8.0 | 6.7 | 6.7 |
| KP40 @ 0.75 l/ha + | 1.3 | 5.3 | 6.0 | 6.0 | 5.3 | 5.3 |
| PF723 @ 1.0 l/ha | | | | | | |

TABLE A5
LETTUCE TRIAL
Percent Powdery Mildew

| Treatment (Applied initially and | Days After First Spray | | |
|---|---|---|---|
| repeated at 10 day intervals) | +16 Days | +20 Days | +24 Days |
| Untreated | 10.0 | 16.7 | 24.7 |
| KP40 @ 0.75 l/ha | 7.3 | 12.0 | 16.0 |
| PF723 @ 1.0 l/ha | 8.0 | 12.0 | 15.3 |
| KP40 @ 0.75 l/ha + | 5.3 | 8.7 | 14.0 |
| PF723 @ 1.0 l/ha | | | |

TABLE A6
Broad Bean - Fertiliser Attributes

| Treatment (2 | Above Ground | Above Ground |
|---|---|---|
| Applications in | Fresh | Dry Weight |
| total - every 15 days) | Weight (g) - Mean | (g) - Mean |
| Untreated | 143.8 | 14.6 |
| KP40 (5.0 l/ha) + | 150.7 | 15.5 |
| PF723 (0.5 l/ha) | | |
| KP40 (3.0 l/ha) + | 160.3 | 16.1 |
| PF723 (0.5 l/ha) | | |
| KP40 (5.0 l/ha) + | 168.0 | 17.3 |
| PF723 (1.0 l/ha) | | |
| KP40 (3.0 l/ha) + | 161.3 | 16.8 |
| PF723 (1.0 l/ha) | | |

(KP40 = 40% Potassium Phosphite;
PF723 = 55% Ammonium Thiosulphate)

TABLE A7
Sugar Beet Percent Powdery Mildew and Fertiliser Attributes

| Treatment | | | Root Fresh | Root Dry | Above Ground | Above Ground |
|---|---|---|---|---|---|---|
| (2 Applications in total - | Days After First Spray | | Weight (g) - | Weight (g) - | Fresh Weight | Dry Weight (g) - |
| every 15 days) | +24 Days | +28 Days | Mean | Mean | (g) - Mean | Mean |
| Untreated | 14 | 24 | 83.0 | 12.2 | 137.8 | 15.3 |
| KP40 (0.375 l/ha) + | 0 | 4 | 90.3 | 12.9 | 142.3 | 15.3 |
| AT60 (10.0 l/ha) | | | | | | |
| KP40 (0.75 l/ha) + | 0 | 2 | 91.7 | 13.9 | 145.0 | 16.4 |
| AT60 (10.0 l/ha) | | | | | | |
| KP40 (0.375 l/ha) + | 0 | 0 | 82.7 | 12.4 | 144.0 | 16.5 |
| AT60 (6.0 l/ha) | | | | | | |
| KP40 (0.75 l/ha) + | 0 | 0 | 97.7 | 13.6 | 145.3 | 15.5 |
| AT60 (6.0 l/ha) | | | | | | |
| KP40 (3.75 l/ha) + | 0 | 6 | 89.7 | 13.2 | 144.0 | 15.8 |
| AT60 (10.0 l/ha) | | | | | | |
| KP40 (2.5 l/ha) + | 2 | 8 | 89.7 | 14.0 | 143.3 | 15.4 |
| AT60 (10.0 l/ha) | | | | | | |
| KP40 (2.5 l/ha) + | 0 | 4 | 98.0 | 13.9 | 146.7 | 16.1 |
| AT60 (6.0 l/ha) | | | | | | |

(KP40 = 40% Potassium Phosphite;
AT60 = 60% Ammonium Thiosulphate)

TABLE A8
Sugar Beet Percent Powdery Mildew and Fertiliser Attributes

| Treatment | | | Root Fresh | Root Dry | Above Ground | Above Ground |
|---|---|---|---|---|---|---|
| (2 Applications in total - | Days After First Spray | | Weight (g) - | Weight (g) - | Fresh Weight | Dry Weight (g) - |
| every 15 days) | +24 Days | +28 Days | Mean | Mean | (g) - Mean | Mean |
| Untreated | 22 | 28 | 109.7 | 13.3 | 144.7 | 14.7 |
| KP40 (0.375 l/ha) + | 0 | 2 | 110.3 | 13.2 | 149.7 | 15.5 |
| AT60 (10.0 l/ha) | | | | | | |
| KP40 (0.75 l/ha) + | 0 | 2 | 118.7 | 13.8 | 147.7 | 15.1 |
| AT60 (10.0 l/ha) | | | | | | |
| KP40 (0.375 l/ha) + | 0 | 6 | 117.7 | 13.6 | 151.3 | 15.0 |
| AT60 (6.0 l/ha) | | | | | | |
| KP40 (0.75 l/ha) + | 2 | 2 | 113.7 | 13.7 | 150.7 | 15.2 |
| AT60 (6.0 l/ha) | | | | | | |
| KP40 (3.75 l/ha) + | 0 | 0 | 119.0 | 14.2 | 150.7 | 15.0 |
| AT60 (10.0 l/ha) | | | | | | |
| KP40 (2.5 l/ha) + | 2 | 0 | 117.3 | 14.7 | 148.7 | 15.0 |
| AT60 (10.0 l/ha) | | | | | | |
| KP40 (2.5 l/ha) + | 2 | 2 | 119.7 | 14.0 | 154.3 | 15.6 |
| AT60 (6.0 l/ha) | | | | | | |

(KP40 = 40% Potassium Phosphite;
AT60 = 60% Ammonium Thiosulphate)

### EXAMPLES B

Solution 1=KP40 at 0.75 l/ha

Solution 3=CS8 at 1.0 l/ha

TABLE B1
Fertiliser Attributes - Strawberry

| | Plant Health | | |
|---|---|---|---|
| Treatment (Applied | ‘Greenness’ | Above Ground | Above Ground |
| initially and repeated | Score (0‥9) | Fresh Weight | Dry Weight |
| after a 10 day | +28 Days | (g) - Mean | (g) - Mean |
| interval) | (×1 Rate) | (×1 Rate) | (×1 Rate) |
| Untreated | 4.8 | 50.8 | 5.0 |
| Solution 1 | 5.6 | 53.7 | 5.1 |
| Solution 3 | 6.0 | 56.0 | 5.6 |
| Solution 1 + | 6.4 | 63.0 | 6.2 |
| Solution 3 | | | |

TABLE B2
Fertiliser Attributes - Spring Barley

| Treatment | Above Ground | Above Ground | Amount of Above |
|---|---|---|---|
| (Applied initially | Fresh Weight | Dry Weight | Ground Tissue |
| and repeated after | (g) - Mean | (g) - Mean | (0-9) |
| a 10 day interval) | (×1 Rate) | (×1 Rate) | (×1 Rate) |
| Untreated | 77.3 | 8.6 | 5.0 |
| Solution 1 | 78.3 | 8.7 | 5.3 |
| Solution 3 | 75.0 | 8.4 | 5.3 |
| Solution 1 + | 81.7 | 9.7 | 5.7 |
| Solution 3 | | | |

TABLE B3
Percent Powdery Mildew - Sugar Beet

| | |
|---|---|
| Treatment (Applied initially and | Days After First Spray |

| repeated after a 10 day | +28 Days | +32 Days |
|---|---|---|
| interval) | (×1 Rate | (×1 Rate) |
| Untreated | 23 | 35 |
| Solution 1 | 6 | 18 |
| Solution 3 | 12 | 20 |
| Solution 1 + | 0 | 12 |
| Solution 3 | | |

TABLE B4
Fertiliser Attributes - Spring Barley

| | | Amount of |
|---|---|---|
| | Amount of | Above Ground |
| Treatment (Applied initially and | Rooting (0-9) | Tissue (0-9) |
| repeated after a 10 day interval | (×1 Rate) | (×1 Rate) |
| Untreated | 5.2 | 5.0 |
| Solution 1 | 5.3 | 5.7 |
| Solution 3 | 6.0 | 5.7 |
| Solution 1 + | 6.3 | 6.0 |
| Solution 3 | | |

TABLE B5
Powdery Mildew - Grape

| Treatment (Applied initially | Days After First Spray | | | | | |
|---|---|---|---|---|---|---|
| and repeated at 10 day | +16 | +20 | +24 | +28 | +32 | +36 |
| intervals) | Days | Days | Days | Days | Days | Days |
| Untreated | 7.3 | 9.3 | 11.3 | 14.0 | 14.0 | 14.7 |
| KP40 @ 0.75 l/ha | 5.3 | 6.7 | 8.0 | 11.3 | 10.7 | 10.7 |
| KS20 @ 1.0 l/ha | 5.3 | 6.7 | 8.0 | 11.3 | 9.3 | 11.3 |
| KP40 @ 0.75 l/ha + | 1.3 | 2.7 | 4.0 | 5.3 | 4.7 | 4.7 |
| KS20 @ 1.0 l/ha | | | | | | |

TABLE B6
% Tuber Blight and Yield Attributes - Potato

| | | | Final Tuber | | |
|---|---|---|---|---|---|
| | | | ‘Quality’ | | |
| Treatment (Applied | | | (Premium | Mean Final ‘First | Relative Final |
| initially and repeated at | Percent Tuber | Final Tuber Yield | Potatoes) | Grade’ Tuber | ‘First Grade’ |
| 10 day intervals) | Blight (%) | (g) | (0-9) | Yield (g) | Tuber Yield (%) |
| Untreated | 6.0 | 241.7 | 4.73 | 114.3 | 100 |
| KP40 @ 0.75 l/ha | 2.7 | 259.8 | 4.67 | 121.3 | 106 |
| KS20 @ 1.0 l/ha | 3.3 | 255.6 | 5.07 | 129.6 | 113 |
| KP40 @ 0.75 l/ha + | 0.7 | 267.4 | 5.67 | 151.6 | 133 |
| KS20 @ 1.0 l/ha | | | | | |

TABLE B7
Percent Foliar Blight - Potato

| Treatment (Applied initially & | Days after First Spray | | | | | |
|---|---|---|---|---|---|---|
| repeated at 10 day | +16 | +20 | +24 | +28 | +32 | +36 |
| intervals) | Days | Days | Days | Days | Days | Days |
| Untreated | 5.3 | 8.7 | 12.7 | 12.7 | 18.7 | 28.0 |
| KP40 @ 0.75 l/ha | 2.7 | 3.3 | 6.7 | 8.7 | 9.3 | 13.3 |
| KS20 @ 1.0 l/ha | 2.0 | 4.0 | 5.3 | 8.0 | 10.0 | 11.3 |
| KP40 @ 0.75 l/ha + | 0.7 | 1.3 | 1.3 | 2.0 | 2.7 | 4.7 |
| KS20 @ 1.0 l/ha | | | | | | |

### EXAMPLES C

Solution 2=PF723 at 1.0 l/ha every 10 days

Solution 3=CS8 at 1.0 l/ha every 10 days

TABLE C1
Percent Powdery Mildew - Grape

| Treatment (Applied Initially | Days After First Spray | | | | | |
|---|---|---|---|---|---|---|
| and repeated at 10 day | +16 | +20 | +24 | +28 | +32 | +36 |
| intervals) | Days | Days | Days | Days | Days | Days |
| Untreated | 7.3 | 9.3 | 11.3 | 14.0 | 14.0 | 14.7 |
| KT47 @ 1.5 l/ha | 4.7 | 6.7 | 8.0 | 9.3 | 9.3 | 9.3 |
| KS20 @ 1.0 l/ha | 5.3 | 6.7 | 8.0 | 11.3 | 9.3 | 11.3 |
| KT47 @ 1.5 l/ha + | 2.7 | 5.3 | 6.7 | 8.7 | 7.3 | 6.7 |
| KS20 @ 1.0 l/ha | | | | | | |

TABLE C2
Fertiliser Attributes - Broad Bean

| Treatment (Applied | Amount of | Above Ground | Above Ground |
|---|---|---|---|
| initially and repeated | Rooting | Fresh Weight | Dry Weight |
| after a 10 day | (0-9) | (g) - Mean | (g) - Mean |
| interval) | (×1 Rate) | (×1 Rate) | (×1 Rate) |
| Untreated | 5.3 | 143.8 | 14.6 |
| Solution 2 | 5.3 | 155.7 | 16.1 |
| Solution 3 | 5.3 | 155.0 | 15.7 |
| Solution 2 + | 5.7 | 163.3 | 16.6 |
| Solution 3 | | | |

TABLE C3
Fertiliser Attributes - Peas

| Treatment | | | | Amount of |
|---|---|---|---|---|
| (Applied | Plant Health | | | Above Ground |
| initially and | ‘Greenness’ | Root Fresh | Root Dry | Tissue |
| repeated | Score (0-9) | Weight | Weight | (0-9) at |
| after a | +28 Days | (g) - Mean | (g) - Mean | Harvest |
| 10 day interval | (×1 Rate) | (×1 Rate) | (×1 Rate) | (×1 Rate) |
| Untreated | 6.1 | 124.2 | 14.1 | 5.5 |
| Solution 2 | 6.2 | 126.3 | 15.1 | 5.3 |
| Solution 3 | 6.2 | 125.7 | 15.1 | 5.7 |
| Solution 2 + | 6.4 | 130.7 | 15.6 | 6.0 |
| Solution 3 | | | | |

TABLE C4
Fertiliser Attributes - Carrot

| Treatment (Applied | Root Dry | Amount | Amount of Above |
|---|---|---|---|
| initially and repeated | Weight (g) - | of Rooting | Ground Tissue (0-9) |
| after a 10 day | Mean | (0-9) | at Harvest |
| interval) | (×1 Rate | (×1 Rate) | (×1 Rate) |
| Untreated | 5.5 | 5.2 | 5.0 |
| Solution 2 | 6.1 | 5.3 | 5.0 |
| Solution 3 | 6.2 | 5.0 | 5.0 |
| Solution 2 + | 6.4 | 5.7 | 5.7 |
| Solution 3 | | | |

TABLE C5
Percent Powdery Mildew - Oilseed Rape

| Treatment (Applied initially | Days After First Spray |
|---|---|
| and repeated after a 10 day | +35 Days |
| interval) | (×1 Rate) |
| Untreated | 14 |
| Solution 2 | 14 |
| Solution 3 | 14 |
| Solution 2 + | 8 |
| Solution 3 | |

TABLE C6
Fertiliser Attributes - Sugar Beet

| Treatment (Applied initially | Root Fresh | Root Dry |
|---|---|---|
| and repeated after a 10 day | Weight (g) - Mean | Weight (g) - Mean |
| interval) | (×1 Rate) | (×1 Rate) |
| Untreated | 109.7 | 13.3 |
| Solution 2 | 111.7 | 13.3 |
| Solution 3 | 113.7 | 13.4 |
| Solution 2 + | 114.7 | 14.1 |
| Solution 3 | | |

TABLE C7
Fertiliser Attributes - Strawberry

| | Plant Health ‘Greenness’ | Amount of |
|---|---|---|
| Treatment (Applied initially | Score (0-9) | Rooting |
| and repeated after | +35 Days | (0-9) |
| a 10 day interval) | (×1 Rate) | (×1 Rate) |
| Untreated | 5.0 | 5.2 |
| Solution 2 | 6.0 | 5.7 |
| Solution 3 | 6.6 | 5.3 |
| Solution 2 + | 7.0 | 6.0 |
| Solution 3 | | |

### EXAMPLES D

TABLE D1
POTATO TRIAL
% Tuber Blight, Final Yield and Quality

| | | | | Final Tuber | | Relative |
|---|---|---|---|---|---|---|
| | | | | ‘Quality’ | Mean Final | Final ‘First |
| Treatment (Applied initially | Percent | | Relative | (Premium | ‘First Grade’ | Grade’ |
| and repeated at 10 day | Tuber Blight | Final Tuber | Final Tuber | Potatoes) | Tuber Yield | Tuber Yield |
| intervals | (%) | Yield (g) | Yield (%) | (0-9) | (g) | (%) |
| Untreated | 6.0 | 241.7 | 100 | 4.73 | 114.3 | 100 |
| KP40 @ 0.75 l/ha | 2.7 | 259.8 | 107 | 4.67 | 121.3 | 106 |
| KT47 @ 1.5 l/ha | 2.7 | 261.7 | 108 | 5.27 | 137.9 | 121 |
| KS20 @ 1.0 l/ha | 3.3 | 255.6 | 106 | 5.07 | 129.6 | 113 |
| KP40 @ 0.75 l/ha + | 0.7 | 271.4 | 112 | 5.60 | 152.0 | 133 |
| KT47 @ 1.5 l/ha | | | | | | |
| KP40 @ 0.75 l/ha + | 0.7 | 267.4 | 111 | 5.67 | 151.6 | 133 |
| KS20 @ 1.0 l/ha | | | | | | |
| KT47 @ 1.5 l/ha + | 0.7 | 272.2 | 113 | 5.60 | 152.4 | 133 |
| KS20 @ 1.0 l/ha | | | | | | |
| KP40 @ 0.75 l/ha + | | | | | | |
| KT47 @ 1.5 l/ha + | 0.7 | 277.0 | 115 | 5.80 | 160.7 | 141 |
| KS20 @ 1.0 l/ha | | | | | | |

TABLE D2
POTATO TRIAL
% Tuber Blight, Yield and Quality Benefits

| | | | Final Tuber | | |
|---|---|---|---|---|---|
| Treatment (Applied initially | | | ‘Quality’ | Mean Final | Relative Final |
| and repeated at 10 day | Percent Tuber | Final Tuber | (Premium | ‘First Grade’ | ‘First Grade’ |
| intervals | Blight (%) | Yield (g) | Potatoes) (0-9) | Tuber Yield (g) | Tuber Yield (%) |
| Untreated | 14.0 | 256.1 | 5.80 | 148.5 | 100 |
| KP40 @ 0.75 l/ha | 10.0 | 271.4 | 5.73 | 155.5 | 105 |
| KT47 @ 1.5 l/ha | 9.3 | 279.2 | 5.80 | 161.9 | 109 |
| KS20 @ 1.0 l/ha | 9.3 | 292.0 | 5.73 | 167.3 | 113 |
| KP40 @ 0.75 l/ha + | 4.0 | 280.4 | 5.80 | 162.6 | 109 |
| KT47 @ 1.5 l/ha | | | | | |
| KP40 @ 0.75 l/ha + | 4.7 | 286.3 | 5.80 | 166.1 | 112 |
| KS20 @ 1.0 l/ha | | | | | |
| KT47 @ 1.5 l/ha + | 3.3 | 290.0 | 5.87 | 170.2 | 115 |
| KS20 @ 1.0 l/ha | | | | | |
| KP40 @ 0.75 l/ha + | 1.3 | 278.0 | 6.07 | 168.7 | 114 |
| KT47 @ 1.5 l/ha + | | | | | |
| KS20 @ 1.0 l/ha | | | | | |

TABLE D3
Spring Barley 1999
Percent Powdery Mildew and Fertiliser Attributes

| | | | | | | | Amount of |
|---|---|---|---|---|---|---|---|
| | | Plant Health | Plant Health | Amount of | Above | Above | Above |
| | Days After | ‘Greenness’ | ‘Greenness’ | Rooting | Ground Fresh | Ground Dry | Ground |
| Treatment (2 Applications) | First Spray | Score (0-9) | Score (0-9) | (0-9) - | Weight (g) - | Weight (g) - | Tissue |
| in total - every 15 days | +20 Days | +28 Days | +35 Days | Mean | Mean | Mean | (0-9) - Mean |
| Untreated | 7 | 5.4 | 5.6 | 5.3 | 68.8 | 7.7 | 5.0 |
| KP40 (0.375 l/ha) + | 2 | 5.8 | 6.0 | 6.0 | 72.7 | 8.4 | 5.3 |
| CS100 (1.0 l/ha) | | | | | | | |
| KP40 (0.75 l/ha) + | 2 | 6.0 | 6.2 | 5.3 | 72.0 | 8.2 | 5.0 |
| CS100 (1.0 l/ha) | | | | | | | |
| KP40 (0.375 l/ha) + | 2 | 5.8 | 5.4 | 6.0 | 75.3 | 8.5 | 5.7 |
| CS100 (0.5 l/ha) | | | | | | | |
| KP40 (0.75 l/ha) + | 4 | 5.6 | 5.8 | 6.3 | 68.7 | 7.5 | 5.3 |
| CS100 (0.5 l/ha) | | | | | | | |
| KP40 (0.375 l/ha) + | 2 | 5.4 | 6.0 | 6.7 | 69.7 | 8.0 | 6.0 |
| CS100 (1.0 l/ha) + | | | | | | | |
| AT60 (10.0 l/ha) | | | | | | | |
| KP40 (0.375 l/ha) + | 2 | 5.6 | 6.2 | 6.0 | 68.7 | 7.9 | 5.7 |
| CS100 (0.5 l/ha) + | | | | | | | |
| AT60 (10.0 l/ha) | | | | | | | |
| KP40 (0.375 l/ha) + | 4 | 5.8 | 5.6 | 6.0 | 62.0 | 7.4 | 5.0 |
| CS100 (0.5 l/ha) + | | | | | | | |
| AT60 (6.0 l/ha) | | | | | | | |
| KP40 (0.375 l/ha) + | 0 | 5.2 | 5.4 | 6.0 | 69.0 | 7.8 | 5.3 |
| CS8 (0.05 l/ha) + | | | | | | | |
| AT60 (10.0 l/ha) | | | | | | | |
| KP40 (0.375 l/ha) + | 2 | 6.0 | 5.6 | 6.7 | 67.7 | 7.5 | 5.0 |
| CS8 (0.05 l/ha) + | | | | | | | |
| AT60 (6.0 l/ha) | | | | | | | |
| KP40 (0.375 l/ha) + | 0 | 5.4 | 5.0 | 5.7 | 89.7 | 7.4 | 5.0 |
| CS8 (0.25 l/ha) + | | | | | | | |
| AT60 (10.0 l/ha) | | | | | | | |
| KP40 (0.375 l/ha) + | 0 | 6.0 | 5.3 | 6.0 | 69.3 | 7.5 | 5.0 |
| CS8 (0.25 l/ha) + | | | | | | | |
| AT60 (6.0 l/ha) | | | | | | | |

(KP40 = 40% Potassium Phosphite:
CS100 = 10% Salicylamide:
CS8 = 20 g/l Salicylamide:
AT60 = 60% Ammonium Thiosulphate)

TABLE D4
Spring Barley
Percent Powdery Mildew and Fertiliser Attributes

| | Amount of Rooting | Above Ground Fresh | Above Ground Dry | Amount of Above |
|---|---|---|---|---|
| Treatment (2 Applications | (0-9) - | Weight (g) - | Weight (g) - | Ground Tissue |
| in total - every 15 Days | Mean | Mean | Mean | (0-9) - Mean |
| Untreated | 5.2 | 73.0 | 9.1 | 5.0 |
| KP40 (0.375 l/ha) + | 6.0 | 83.0 | 9.3 | 5.3 |
| CS100 (1.0 l/ha) | | | | |
| KP40 (0.75 l/ha) + | 5.7 | 82.0 | 9.7 | 5.3 |
| CS100 (1.0 l/ha) | | | | |
| KP40 (0.375 l/ha) + | 5.0 | 77.7 | 8.6 | 6.0 |
| CS100 (0.5 l/ha) | | | | |
| KP40 (0.75 l/ha) + | 6.0 | 76.7 | 8.7 | 5.0 |
| CS100 (0.5 l/ha) | | | | |
| KP40 (0.375 l/ha) + | 6.0 | 67.3 | 7.8 | 5.0 |
| CS100 (1.0 l/ha) + | | | | |
| AT60 (10.0 l/ha) | | | | |
| KP40 (0.375 l/ha) + | 6.0 | 68.3 | 8.1 | 5.0 |
| CS100 (0.5 l/ha) + | | | | |
| AT60 (10.0 l/ha) | | | | |
| KP40 (0.375 l/ha) + | 6.0 | 78.3 | 9.1 | 5.7 |
| CS100 (0.5 l/ha) + | | | | |
| AT60 (6.0 l/ha) | | | | |
| KP40 (0.375 l/ha) + | 5.7 | 76.0 | 8.8 | 5.7 |
| CS8 (0.05 l/ha) + | | | | |
| AT60 (10.0 l/ha) | | | | |
| KP40 (0.375 l/ha) + | 6.0 | 78.3 | 9.0 | 5.7 |
| CS8 (0.05 l/ha) + | | | | |
| AT60 (5.0 l/ha) | | | | |
| KP40 (0.375 l/ha) + | 5.0 | 71.7 | 8.5 | 5.3 |
| CS8 (0.25 l/ha) + | | | | |
| AT60 (10.0 l/ha) | | | | |
| KP40 (0.375 l/ha) + | 5.7 | 72.0 | 8.1 | 5.0 |
| CS8 (0.25 l/ha) + | | | | |
| AT60 (6.0 l/ha) | | | | |

(KP40 = 40% Potassium Phosphite:
CS100 = 10% Salicylamide:
CS8 = 20 g/l Salicylamide:
AT60 = 60% Ammonium Thiosulphate)

TABLE D5
LETTUCE TRIAL
Fresh Weight Yield and Quality Benefits

| | | Quality | Final Fresh | | | | | Relative |
|---|---|---|---|---|---|---|---|---|
| Treatment (Applied | Final | of Final | Weight | Relative Fresh | | Median Quality of | Median Final | Median |
| initially and | Fresh | Fresh | ‘Quality’ | Weight | Median Final | Final Fresh | Fresh Weight | Fresh Weight |
| repeated at | Weight | Weight | Yield | ‘Quality’ | Fresh Weight | Weight Yield | ‘Quality’ Yield | ‘Quality’ Yield |
| 10 day intervals) | Yield (g) | Yield (0-9) | (g) | Yield (%) | Yield (g) | (0-9) | (g) | (%) |
| Untreated | 81.3 | 5.33 | 43.4 | 100 | 80.6 | 5.27 | 42.5 | 100 |
| KP40 @ 0.75 l/ha | 85.0 | 5.40 | 45.7 | 105 | 87.2 | 5.36 | 46.7 | 110 |
| PF723 @ 1.0 l/ha | 87.7 | 5.40 | 47.4 | 109 | 86.6 | 5.46 | 47.3 | 111 |
| KS20 @ 1.0 l/ha | 83.6 | 5.67 | 47.4 | 109 | 82.6 | 5.64 | 46.6 | 110 |
| KP40 @ 0.75 l/ha + | 89.8 | 5.63 | 50.6 | 117 | 89.8 | 5.64 | 50.6 | 119 |
| PF723 @ 1.0 l/ha | | | | | | | | |
| KP40 @ 0.75 l/ha + | 90.9 | 5.53 | 50.3 | 116 | 90.6 | 5.64 | 51.1 | 120 |
| KS20 @ 1.0 l/ha | | | | | | | | |
| PF723 @ 1.0 l/ha + | 86.5 | 5.67 | 49.0 | 113 | 85.4 | 5.64 | 48.2 | 113 |
| KS20 @ 1.0 l/ha | | | | | | | | |
| KP40 @ 0.75 l/ha + | 87.9 | 5.67 | 49.8 | 115 | 88.4 | 5.64 | 49.9 | 117 |
| PF723 @ 1.0 l/ha + | | | | | | | | |
| KS20 @ 1.0 l/ha | | | | | | | | |

(KP40 = 40% Potassium Phosphite;
PF723 = 55% Ammonium Thiosulphate;
KS20 = 20 gms/litre Potassium Salicylate)

### EXAMPLES E

TABLE E1
Benefits of Ammonium Thiosulphate (ATS) and Potassium Salicylate (KS)
with Chlormequat (CCC) on Spring Barley

| | Powdery | Amount of | Above Ground | Above Ground |
|---|---|---|---|---|
| Treatment | Mildew (%) | Rooting (0-9) | Fresh Weight (g) | Dry Weight (g) |
| (Treatments applied at | at +15 | Mean of 10 | Total of 10 | Total of 10 |
| 3 leaves stage) | days | plants | plants | plants |
| Untreated | 25 | 5.8 | 30.5 | 3.4 |
| CCC (1.25 l/ha) | 15 | 5.5 | 34.0 | 3.7 |
| CCC (1.25 l/ha) + | 13 | 6.0 | 31.5 | 3.6 |
| ATS (1.25 l/ha) | | | | |
| CCC (1.25 l/ha) + | 18 | 6.0 | 31.3 | 3.5 |
| KS (20 g/ha) | | | | |
| CCC (1.25 l/ha) + | 8 | 6.5 | 36.0 | 4.0 |
| ATS (1.25 l/ha) + | | | | |
| KS (20 g/ha) | | | | |

TABLE E2
Benefits of Ammonium Thiosulphate (ATS) and Potassium Salicylate (KS)
with Chlormequat (CCC) on Spring Barley

| Treatment | | | | Number of |
|---|---|---|---|---|
| (Treatments applied at 3 | | | | Tillers |
| leaves stage (T1) and | Powdery | Powdery | Powdery | Initiated per |
| prior to start of stem | Mildew (%) | Mildew (%) | Mildew (%) | Plant (mean of |
| extension (T2)) | at +12 days | at +15 days | at +18 days | 10 plants) |
| Untreated | 20 | 25 | 38 | 3.0 |
| CCC (0.8 l/ha at T1 & T2) | 8 | 8 | 10 | 3.5 |
| CCC (0.8 l/ha at T1 & T2) + | 5 | 5 | 8 | 3.5 |
| ATS (0.8 l/ha at T1 & T2) | | | | |
| CCC (0.8 l/ha at T1 & T2) + | 8 | 8 | 13 | 3.3 |
| KS (20 g/ha at T1 & T2) | | | | |
| CCC (0.8 l/ha at T1 & T2) + | 0 | 3 | 5 | 4.3 |
| ATS (0.8 l/ha at T1 & T2) + | | | | |
| KS (20 g/ha at T1 & T2) | | | | |

The following show non-limiting examples of formulated compositions in accordance with the present invention

FOLIAR FERTILISER ONE

| | Specific | Kilogram percentage | | Volume | gram/litre | gram/litre |
|---|---|---|---|---|---|---|
| INGREDIENTS | Gravity | per batch | w/w | per batch | of ingredient | of active |
| Water | 1.000 | 150.0000 | 7.50000 | 150.0000 | 96.2564 | 96.2564 |
| Wetting agent | 1.000 | 10.0000 | 0.50000 | 10.0000 | 6.4171 | 6.4171 |
| Salicylic Acid | 1.000 | 10.0000 | 0.50000 | 10.0000 | 6.4171 | 6.4171 |
| Potassium hydroxide (20% w/w) | 1.200 | 130.0000 | 6.50000 | 108.3333 | 83.4222 | 83.4222 |
| Copper EDTA chelate (14.3% Cu w/w) | 1.200 | 30.0000 | 1.50000 | 25.0000 | 19.2513 | 19.2513 |
| Iron EDTA chelate (13.2% Fe w/w) | 1.200 | 30.0000 | 1.50000 | 25.0000 | 19.2513 | 19.2513 |
| Pot. phosphites (42% w/w) | 1.342 | 1,000.0000 | 50.00000 | 745.1565 | 641.7092 | 269.5179 |
| Ammonium thiosulphate (60% w/w) | 1.320 | 640.0000 | 32.00000 | 484.8485 | 410.6939 | 246.4163 |
| Totals | | 2,000.0000 | 100.00000 | 1,558.3383 | 1,283.4184 | 746.9495 |

| | | |
|---|---|---|
| N | 3.84% w/w | 49 g/litre w/v |
| P | 4.68% w/w | 60 g/litre w/v |
| P as P₂O₅** | 10.64% w/w | 137 g/litre w/v |
| K | 9.91% w/w | 125 g/litre w/v |
| K as K₂O | 11.93% w/w | 150 g/litre w/v |
| S | 8.32% w/w | 107 g/litre w/v |
| S as SO₃ | 20.80% w/w | 261 g/litre w/v |

**theoretically

FOLIAR FERTILISER TWO

| | Specific | Kilogram percentage | | Volume | gram/litre | gram/litre |
|---|---|---|---|---|---|---|
| INGREDIENTS | Gravity | per batch | w/w | per batch | of ingredient | of active |
| Water | 1.000 | 150.0000 | 7.50000 | 150.0000 | 96.2564 | 96.2564 |
| Wetting agent | 1.000 | 10.0000 | 0.50000 | 10.0000 | 6.4171 | 6.4171 |
| Zinc EDTA chelate (15.7% Zn w/w) | 1.000 | 30.0000 | 1.50000 | 30.0000 | 19.2513 | 19.2513 |
| Copper EDTA chelate (14.3% Cu w/w) | 1.000 | 30.0000 | 1.50000 | 30.0000 | 19.2513 | 19.2513 |
| Iron EDTA chetale (13.2% Fe w/w) | 1.000 | 30.0000 | 1.50000 | 30.0000 | 19.2513 | 19.2513 |
| Pot. phosphites (42% w/w) | 1.342 | 750.0000 | 37.50000 | 558.8674 | 481.2819 | 202.1384 |
| Ammonium thiosulphate (60% w/w) | 1.320 | 1,000.0000 | 50.00000 | 757.5758 | 641.7092 | 385.0255 |
| Totals | | 2,000.0000 | 100.00000 | 1,566.4431 | 1,283.4184 | 747.5912 |

| | | |
|---|---|---|
| N | 6.00% w/w | 77 g/litre w/v |
| P | 3.51% w/w | 45 g/litre w/v |
| P as P₂O₅** | 7.98% w/w | 102 g/litre w/v |
| K | 6.96% w/w | 88 g/litre w/v |
| K as K₂O | 8.39% w/w | 105 g/litre w/v |
| S | 13.00% w/w | 167 g/litre w/v |
| S as SO₃ | 32.50% w/w | 417 g/litre w/v |

**theoretically

The above Examples show that the compositions of the present invention show the desired fertilisation and antifungal effects.

1. A fertiliser composition comprising at least one phosphonate and at least one thiosulphate.

2. A fertiliser composition according to claim 1 wherein the phosphonate is selected from the group consisting of ammonium, sodium, potassium phosphonate and a mixture thereof

3. A fertiliser composition according to claim 1 wherein the thiosulphate is selected from the group consisting of ammonium, sodium, potassium thiosulphate and a mixture thereof.

4. A fertiliser composition according to claim 1 further comprising at least one selected from the group consisting of salicylic acid, a homologue, a derivative, and a salt thereof.

5. A fertiliser composition according to claim 4 wherein the derivative of salicylic acid is selected from the group consisting of salicylamide and a salt thereof

6. A fertiliser composition according to claim 4 wherein the homologue of salicylic acid is selected from the group consisting of benzoic acid, a salt and derivative thereof.

7. A fertiliser composition according to claim 4 wherein the salt is selected from the group consisting of an organic and inorganic salt.

8. A fertiliser composition according to claim 4 wherein the salt is selected from the group consisting of a sodium, potassium salt and mixtures thereof.

9. A fertiliser composition according to claim 1 in the form of a concentrate.

10. A fertiliser composition according to claim 1 in the form of an aqueous solution.

11. A fertiliser composition according to claim 10 comprising 150 g/l phosphonate, 275 g/l thiosulphate and optionally 10 g/l salicylamide.

12. A fertiliser composition according to claim 10 wherein the phosphonate comprises 75 g/l mono-potassium phosphonate and 75 g/l di-potassium phosphonate.

13. A fertiliser composition according to any claim 1 further comprising a plant growth regulator.

14. A fertiliser composition according to claim 13 wherein the plant growth regulator is chlormequat.

15. A fertiliser composition according to any claim 1 further comprising a nutrient.

16. A fertiliser composition according to claim 1 further comprising a nutrient selected from the group consisting of nitrogen, phosphorus, potassium, calcium, magnesium, sulfur, boron zinc, copper and mixtures thereof.

17. A fertiliser composition according to claim 1 further comprising a vitamin.

18. A fertiliser composition according to any claim 1 further comprising a vitamin selected from the group consisting of niacin, d-Biotin, riboflavin, ascorbic acid, thiamine mononitrate, thiamine hygrochloride, pyridoxine hydrochloride and folic acid.

19. A fertiliser composition according to claim 1 further comprising a growth promoter.

20. A fertiliser composition according to claim 1 further comprising a growth promoter selected from the group consisting of cytokinins, purines, gibberellins and auxins.

21. A fertiliser composition according to claim 1 further comprising an amino acid.

22. A fertiliser composition according to claim 1 further comprising an amino acid selected from the group consisting of alanine, arginine, aspartic acid, betaines, choline, cysteine, glutaminc acid, glycine, histidine, isoleucine, leucine, lysine, methionine, phenylalanine, proline, serine, threonine, tryptophan, tyrosine and valine.

23. A fertiliser composition according to claim 1 further comprising a carbohydrate.

24. A fertiliser composition according to claim 1 further comprising a polysaccharide.

25. A fertiliser composition according to claim 1 further comprising a carbohydrate selected from the group consisting of alginic acid, mannitol, laminarin, succinic acid, sorbitol, fructose, sucrose, dextrose, lactose and mixtures thereof.

26. A fertiliser composition according to claim 1 further comprising an adjuvant.

27. A fertiliser composition according to claim 1 further comprising an adjuvant selected from the group consisting of alcohol ether sulfates, alcohol sulfates, alkylaryl ether sulfates, alkylaryl sulfonates, carboxylated nonionics, naphthalene, sulfonates, phosphate esters, sulfonic acids, sulfosuccinates, terpenes, alcohol ethers, alkoxylated alkylphenol resins, alkoylated vegetable oils, esterified seed oils, alkylphenol ethers, block co-polymers, sorbitol, sorbitan alkoxylates and sorbitan esters, alkanolamides, amine ethoxylates, methyl esters of fatty acids, fatty acid alkyloxalates and fattyt acid resins, terpene, and mixtures thereof.

28. A method for fertilising a plant comprising applying a fertiliser composition according to claim 1 to the plant or its environs.

29. A method according to claim 28 wherein the phosphonate is applied at 150 g/ha to 2 kg/ha.

30. A method according to claim 28 wherein the thiosulphate is applied at 250 g/ha to 6 kg/ha.

31. Use of a fertiliser composition according to claim 1 to stimulate plant growth.

32. Use of a fertiliser composition according to claim 1 to control parasitic fungi.
